(19) United States
(12) Patent Application Publication
(10) Pub. No.: US 2007/0263896 A1
(43) Pub. Date: Nov. 15, 2007

(54) Sheathing-type earphone structure

(75) Inventor: Kuo-Chung Chen, Taipei Hsien (TW)

Correspondence Address: TROXELL LAW OFFICE PLLC, SUITE 1404, 5205 LEESBURG PIKE, FALLS CHURCH, VA, 22041, US

(73) Assignee: Jdi Jing Deng Industrial Co., Ltd.

(21) Appl. No.: 11/481,947

(22) Filed: Jul. 7, 2006

(30) Foreign Application Priority Data
May 12, 2006 (TW) 095208125

(51) Int. Cl. H04R 25/00

(52) U.S. Cl. 381/381; 381/374

(57) ABSTRACT

A sheathing-type earphone structure is composed of a seat, an end of which is extended with an ear-loop being parallel connected to the other end of which, and which is opened with a through-hole; an earphone body, which is formed integrally, and is correspondingly sheathed in the aforementioned seat, an end of which is extended with a leading wire being transfixed out of the aforementioned through-hole and being connected to a sound source. Accordingly, when a user sheaths the earphone on ears for listening, if the leading wire is carelessly pulled, the seat will become a buffer due to that the through-hole of seat provides for the transfixing of leading wire of earphone body, thereby preventing the leading wire from being broken at a connection position of the earphone, by excessively pulling.

### BACKGROUND OF THE INVENTION

(a) Field of the Invention

The present invention relates to a sheathing-type earphone structure, and more particularly to a sheathing-type earphone structure, which is able to prevent a leading wire from being easily broken at a connection position of the earphone body by excessively pulling due to a careless application upon sheathing on ears for use.

(b) Description of the Prior Art

An earphone is a kind of tool for transmitting sound, which is widely used in communicating, tutoring, or listening to music. From a long term of development, the structure of earphone is very versatile, including such as an earflap earphone, an earplug earphone, or an ear-loop earphone, wherein as the ear-loop earphone does not need a heavy and awkward head band, and is not easy to cause pain and discomfort due to that ear holes are plugged, like the earplug earphone, it is especially appreciated by users, and is also provided with a high acceptability in the market.

Referring to FIG. 1 and FIG. 2, the conventional ear-loop earphone includes an earphone body a which is constituted by a speaker a1 with its back side being covered with a cap a2; an ear-loop b which is fixed between the speaker a1 and the cap a2, and is extending outward to form a loop structure using the earphone body a as a center; and a leading wire c which is extended between the speaker a1 and the cap a2.

According to the aforementioned structure, the ear-loop b can be sheathed on a user's ear, such that the earphone body a at the center of ear-loop b can be exactly positioned at an ear hole. In application, sound signals will be transmitted from a sound source to the earphone body a to be played, through the leading wire c.

However, there are still following shortcomings in practically using the aforementioned structure:
1. As the leading wire c should be connected to the sound source (such as a walkman, or a radio set) from the earphone body a to allow the earphone body a to play the sound besides the user's ears, the leading wire c will be extended very long. Therefore, when the user swings his or her head carelessly, or performs any stretching, the leading wire c will be wiggled, such that a connection end between the leading wire c and the earphone body a is sustained to a huge pulling force, which will cause a breakage to a metallic wire inside the leading wire c, and seriously affect a lifetime of usage of the entire ear-loop earphone.
2. Each person will have ears of very different sizes. Although the conventional ear-loop b is provided with flexibility, it will squeeze at the ear to allow a person with larger ears to feel uncomfortable, and can even injure the ear in forcefully sheathing on the ear-loop.

In view of the shortcomings in practical applications of the aforementioned conventional ear-loop earphone, a kind of sheathing-type earphone structure is invented.

### SUMMARY OF THE INVENTION

The primary object of present invention is to provide a sheathing-type earphone structure which provides a buffer to a leading wire when it is pulled, in order to prevent a metallic wire inside the leading wire from being broken, thereby prolonging its lifetime of usage.

Accordingly, the present invention provides a sheathing-type earphone structure which includes a seat, an end of which is extended with an ear-loop being parallel connected to the other end of which, and which is opened with a through-hole; and an earphone body formed integrally, which is correspondingly sheathed in the aforementioned seat, and an end of which is extended with a leading wire being transfixed out of the aforementioned through-hole and connected to a sound source.

According to the aforementioned structure, when a user sheaths the earphone on ears for listening, if the leading wire is carelessly pulled, the seat will become a buffer, due to that the through-hole of seat provides for a transfixing of the leading wire of earphone body, which will prevent the leading wire to be broken at a connection position to the earphone body by excessively pulling.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a perspective view of a conventional earphone.

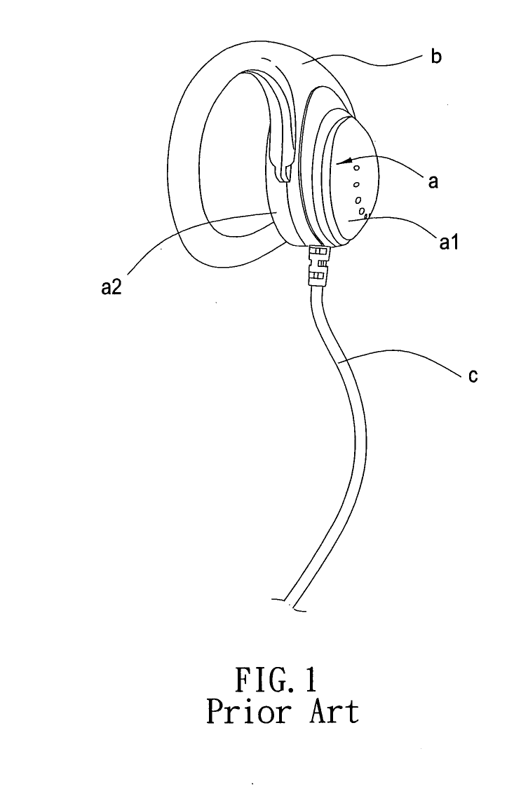

FIG. 2 shows a side view of a conventional earphone.

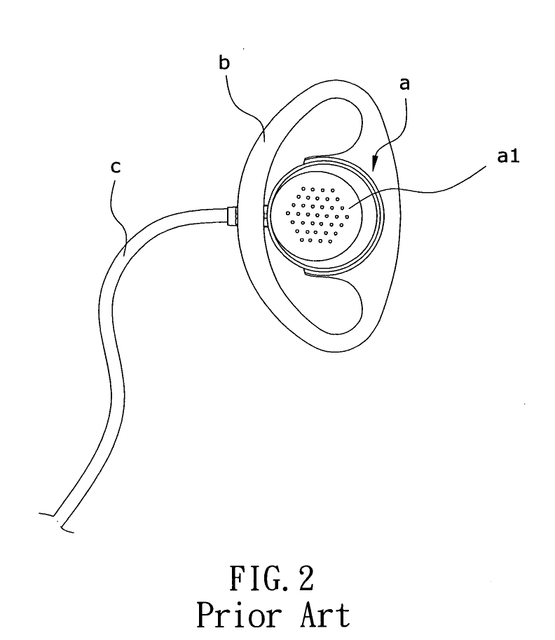

FIG. 3 shows a perspective view of the present invention.

FIG. 4 shows an exploded view of the present invention.

FIG. 5 shows a side view of the present invention.

FIG. 6 shows a schematic view of an embodiment of the present invention.

### DETAILED DESCRIPTION OF THE PREFERRED EMBODIMENTS

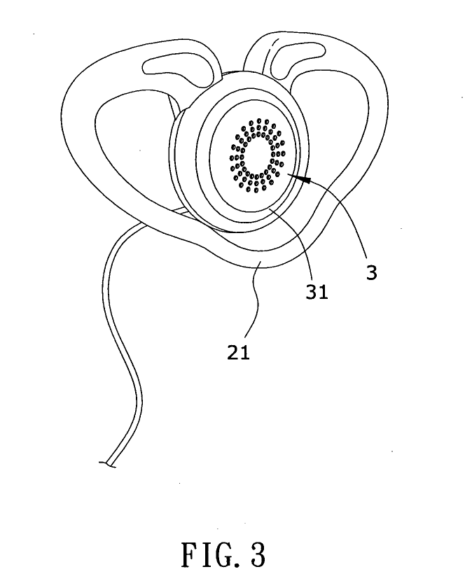

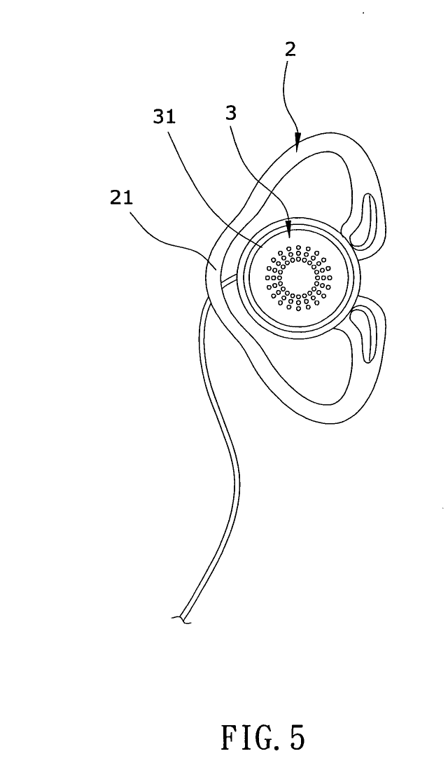

Referring to FIGS. 3 to 5, the present invention comprises a seat 1 and an earphone body 3, wherein the seat 1 is opened with a through-hole 11, an end of the seat 1 is extended with an ear-loop 2 which is parallel connected to the other end of the seat 1, the ear-loop 2 is made by a silicon material with elasticity, and a side rim of the ear-loop 2 is bended into an elastic part 21. The earphone body 3 is primarily constituted by a speaker 31, which is formed integrally with a cap 32 being covered at a back side of the speaker 31. The earphone body 3 is correspondingly sheathed in the aforementioned seat 1, and an end of the earphone body 3 is extended with a leading wire 4, which is transfixed out of the aforementioned through-hole 11 and is connected to a sound source.

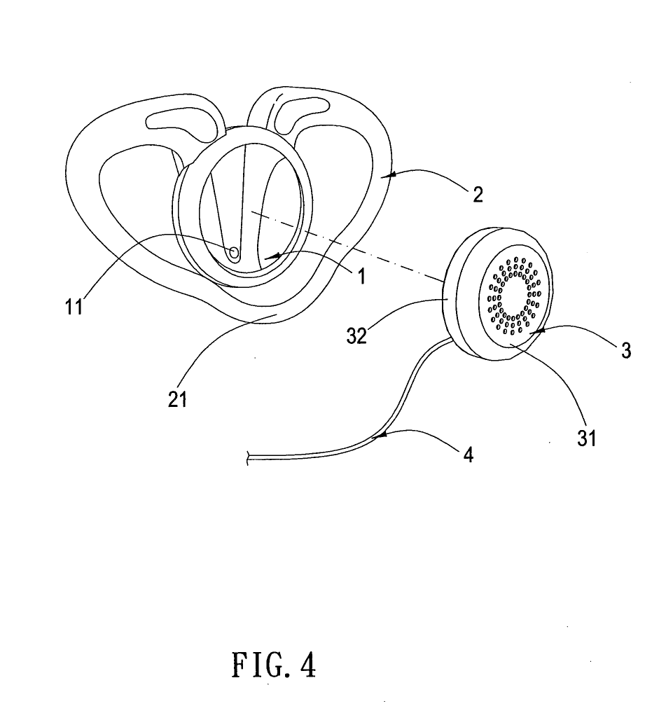

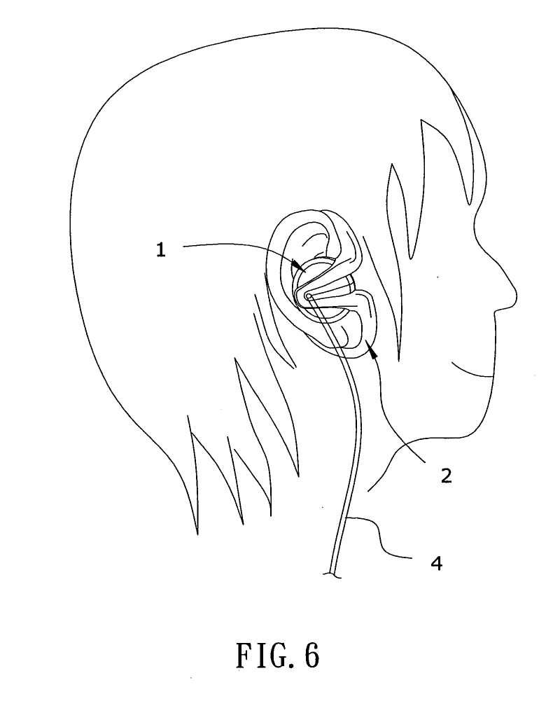

Referring to FIG. 4 to 6, in implementing according to the aforementioned structure, when a user sheaths the ear-loop 2 on his or her ear, a buffer to pulling can be provided by the elastic part 21 which is bended at the side rim of ear-loop 2, such that a periphery of the ear-loop 2 can be expanded to be successfully sheathed into the user's ear, without allowing the user to feel pain. In addition, the seat 1 at a center of the ear-loop 2 can be exactly positioned at an ear hole of the user, such that the earphone body 3 inside the seat 1 can be aligned with the user's ear hole. In application, sound signals will be transmitted from the sound source to the earphone body 3 to be played, through the leading wire 4. When the user swings his or her head carelessly, or performs any stretching to cause the leading wire 4 to wiggle and to create a pulling force at the same time, the seat 1 is provided with the through-hole 11 for transfixing the leading wire 4 of earphone body 3, such that the seat 1 will become a buffer between the leading wire 4 and the earphone body 3 to lessen the pulling force of leading wire 4, thereby preventing a tiny metallic wire inside the leading wire 4 from being broken at the connection position of the earphone body 3 by excessively pulling.

Accordingly, the present invention is provided with the following advantages:
1. The seat 1 is provided with the through-hole 11 for transfixing the leading wire 4 of earphone body 3, such that the seat 1 will become a buffer between the leading wire 4 and the earphone body 3, to prevent the user from carelessly pulling the leading wire 4, so as to cause the tiny metallic wire inside the leading wire 4 to be broken at the connection position of the earphone body 3; thereby improving an overall lifetime of usage.
2. The present invention can provide the buffer to pulling by the elastic part 21 which is bended at the side rim of ear-loop 2, such that the ear-loop 2 can be successfully sheathed into the user's ear, to avoid causing pain to the user with larger ears during a process of sheathing.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A sheathing-type earphone structure including a seat, an end of which is extended with an ear-loop being parallel connected to the other end of which, and which is opened with a through-hole; an earphone body, which is formed integrally, is correspondingly sheathed in the aforementioned seat, and an end of which is extended with a leading wire being transfixed out of the aforementioned through-hole and being connected to a sound source; the seat becoming a buffer by the through-hole for transfixing the leading wire of earphone body, so as to prevent the leading wire to be broken at a connection position of the earphone body, by excessively pulling.

2. The sheathing-type earphone structure according to claim 1, wherein the earphone body is constituted by a speaker with its back side being covered with a cap.

3. The sheathing-type earphone structure according to claim 1, wherein a side rim of the ear-loop is bended into an elastic part.

4. The sheathing-type earphone structure according to claim 1, wherein the ear-loop is made by a soft material with elasticity.

5. The sheathing-type earphone structure according to claim 1, wherein the ear-loop is made by a silicon material.
